(19) United States
(12) Patent Application Publication
(10) Pub. No.: US 2026/0322936 A1
(43) Pub. Date: Oct. 15, 2026

(54) STORAGE MEDIUM STORING APPLICATION PROGRAM THAT, WHEN CAUSING IMAGE PROCESSING APPARATUS INCLUDING READING FUNCTION FOR READING DOCUMENT TO EXECUTE THE READING FUNCTION, IS CAPABLE OF CAUSING TO EXECUTE START RESTRICTION FUNCTION WITHOUT USING SCAN DRIVER, CONTROL METHOD, AND INFORMATION PROCESSING APPARATUS

(71) Applicant: CANON KABUSHIKI KAISHA, Tokyo (JP)

(72) Inventor: YASUHIRO TAKAHASHI, Chiba (JP)

(21) Appl. No.: 19/465,440

(22) Filed: Jan. 30, 2026

(30) Foreign Application Priority Data
Feb. 17, 2025 (JP) 2025-023544

(51) Int. Cl. H04N 1/00

(52) U.S. Cl. CPC H04N 1/00925; H04N 1/0048

(57) ABSTRACT

A mechanism that, when causing an image processing apparatus including a reading function for reading a document to execute the reading function, can cause to execute a start restriction function without using a scan driver is provided. A non-transitory computer-readable storage medium stores an application program, which supports a standard driver provided by a provider of an operating system, for causing a computer to execute a step of obtaining, from an image processing apparatus including a reading function for reading a document, state information relating to a state of the image processing apparatus, a determining step of determining whether or not the image processing apparatus is capable of executing the reading function based on the obtained state information, and a step of, in a case of being determined in the determining step that an instruction to execute the reading function is allowed, issuing the instruction to execute the reading function.

### BACKGROUND

### Field of the Technology

The present disclosure relates to a storage medium storing an application program, a control method, and an information processing apparatus.

### Description of the Related Art

A host computer (an information processing apparatus) capable of processing information to and from a scan apparatus is communicably connected to the scan apparatus (a scanner) that performs image reading, that is, performs scanning. As control software for controlling the scan apparatus, for example, a scan driver installed from the scan apparatus on the host computer is used. The scan driver allows the host computer to issue a scan instruction to the scan apparatus, that is, the scan driver allows to perform a remote scan. An operating system (hereinafter, referred to as “an OS”), which is basic software, has been installed in advance on the host computer. The scan driver is configured in accordance with specifications defined by the OS, and is able to operate (run) by being invoked from the OS. In addition, such scan drivers differ depending on vendors that supply scan apparatuses, that is, the scan drivers are model-specific scan drivers suitable for the respective scan apparatuses.

In recent years, Windows (registered trademark) has been trying to provide a standard class driver (hereinafter, sometimes referred to as “a standard driver”) that is capable of being used in common even for scan apparatuses supplied by a plurality of different vendors. Such a standard driver has been built into the OS in advance. Furthermore, it is possible to use the standard driver by connecting any scan apparatus to the host computer having the OS, into which the standard driver has been built. As a result, it is possible to omit installing the model-specific scan driver. In addition, the standard driver is assumed to be configured to be capable of designating a scan function included in the scan apparatus in accordance with scan function information generated based on information obtained from the scan apparatus. As a result, it is possible to designate the scan function for each scan apparatus by using one standard driver.

In addition, since the standard driver is capable of being commonly used for the scan apparatuses supplied by the plurality of different vendors, for example, it may become impossible for the standard driver to cause a scan apparatus supplied by a predetermined vendor to execute some of the functions included in the scan apparatus supplied by the predetermined vendor. Japanese Laid-Open Patent Publication (kokai) No. 2021-033526 discloses a print extension application that, even in the case where it becomes impossible to execute some of print functions in a document creation application, enables some of the print functions to be executed, that is, that extends the print functions.

As described above, the scan drivers differ depending on the vendors that supply the scan apparatuses, that is, the scan drivers are model-specific scan drivers suitable for the respective scan apparatuses. The scan drivers include a driver including a start restriction function (a start control function) that restricts (does not allow) the start of reading (scanning) of a document. For example, when a first user and a second user use one scan apparatus, a timing at which a document is read by the one scan apparatus in response to an operation from the first user and a timing at which a document is read by the one scan apparatus in response to an operation from the second user may overlap. In this case, the start restriction function is capable of preventing the document of the second user from being erroneously read by an operation from the first user. On the other hand, the standard driver is not a driver that includes the start restriction function.

### SUMMARY

The present disclosure provides a mechanism that, when causing an image processing apparatus including a reading function for reading a document to execute the reading function, is capable of causing to execute a start restriction function without using a scan driver.

Accordingly, a first aspect of the present disclosure provides a non-transitory computer-readable storage medium storing an application program, which supports a standard driver provided by a provider of an operating system, for causing a computer to execute an obtaining step of obtaining, from an image processing apparatus including a reading function for reading a document, state information relating to a state of the image processing apparatus, a determining step of determining whether or not the image processing apparatus is capable of executing the reading function based on the state information that has been obtained in the obtaining step, and an instructing step of, as a result of the determination in the determining step, in a case of being determined that an instruction to execute the reading function is allowed, issuing the instruction to execute the reading function.

Accordingly, a second aspect of the present disclosure provides an information processing apparatus comprising a standard driver provided by a provider of an operating system and an application program that supports the standard driver. The application program causes a computer of the information processing apparatus to execute an obtaining step of obtaining, from an image processing apparatus including a reading function for reading a document, state information relating to a state of the image processing apparatus, a determining step of determining whether or not the image processing apparatus is capable of executing the reading function based on the state information that has been obtained in the obtaining step, and an instructing step of, as a result of the determination in the determining step, in a case of being determined that an instruction to execute the reading function is allowed, issuing the instruction to execute the reading function.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of a scan system according to a first embodiment.

FIG. 2A and FIG. 2B are block diagrams that illustrate software configurations of the scan system.

FIG. 3A, FIG. 3B, and FIG. 3C are diagrams that illustrate examples of screens displayed on a display unit of the scan system.

FIG. 4 is a flowchart that illustrates a processing in which a scan function extending unit edits scan function information.

FIG. 5 is a diagram that illustrates examples of a list table of scan information.

FIG. 6 is a sequence diagram that illustrates processes executed between a scan application, general purpose scan software, an extension application, and a scan apparatus after the scan application accepts a scan setting.

FIG. 7 is a flowchart that illustrates a processing executed by the extension application.

FIG. 8 is a diagram that illustrates an example of a screen displayed on the display unit of the scan system in a step S710 of the flowchart illustrated in FIG. 7.

FIG. 9A, FIG. 9B, and FIG. 9C are diagrams that illustrate examples of screens displayed on the display unit of the scan system.

FIG. 10 is a flowchart that illustrates a processing executed by the scan apparatus.

FIG. 11A, FIG. 11B, FIG. 11C, and FIG. 11D are diagrams for explaining an image processing according to a document orientation.

FIG. 12 is a flowchart that illustrates a processing executed by an extension application according to a second embodiment.

FIG. 13 is a sequence diagram that illustrates processes executed between a scan application according to a third embodiment, the general purpose scan software, the extension application, and the scan apparatus after the scan application according to the third embodiment accepts a scan setting.

### DESCRIPTION OF THE EMBODIMENTS

The present disclosure will now be described in detail below with reference to the accompanying drawings showing embodiments thereof.

Hereinafter, each embodiment of the present disclosure will be described in detail with reference to the drawings. However, the configuration described in each embodiment below is merely an example, and the scope of the present disclosure is not limited by the configuration described in each embodiment. For example, each unit (each component) constituting the present disclosure can be replaced with a unit (a component) with any configuration that can perform the same function(s). In addition, any component(s) may be added. Furthermore, any two or more configurations (features) of each embodiment can be combined.

### First Embodiment

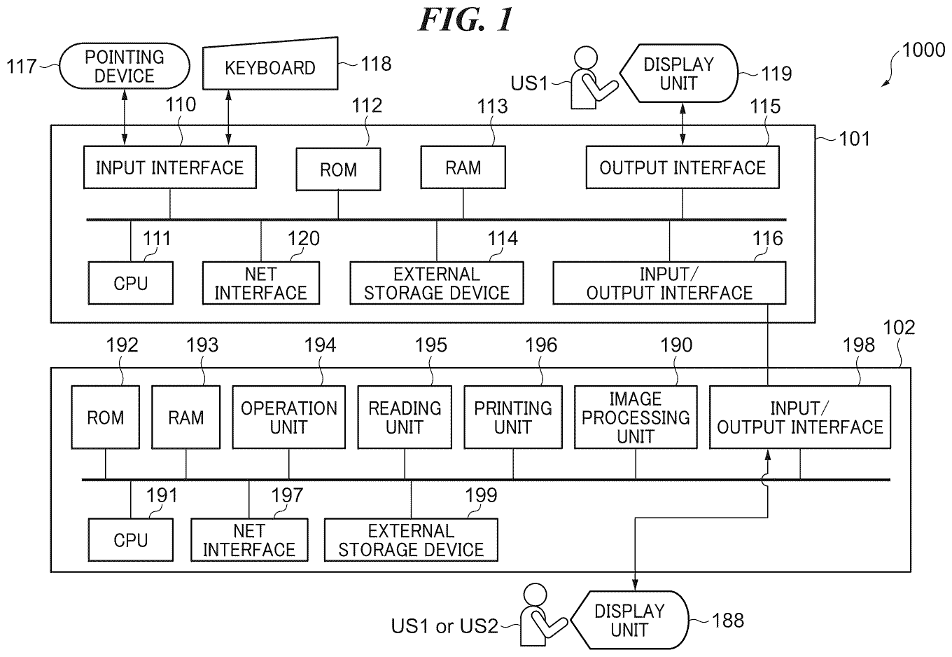

A first embodiment of the present disclosure will be described below with reference to FIGS. 1 to 11D.

### Hardware Configuration of Scan System

FIG. 1 is a block diagram that illustrates a hardware configuration of a scan system according to the first embodiment. As shown in FIG. 1, a scan system 1000 includes a host computer 101, a scan apparatus (a scanner) 102, a pointing device 117, a keyboard 118, and a display unit 119, and the host computer 101, the scan apparatus 102, the pointing device 117, the keyboard 118, and the display unit 119 are communicably connected to each other. In the first embodiment, the host computer 101, the pointing device 117, the keyboard 118, and the display unit 119 are used by a user US1. The scan apparatus 102 is used by the user US1 or a user US2. The host computer 101 is an information processing apparatus. The host computer 101 includes an input interface 110, a central processing unit (a CPU) 111, a read only memory (a ROM) 112, a random access memory (a RAM) 113, an external storage device (a storage medium) 114, an output interface 115, an input/output interface 116, and a NET interface 120. It should be noted that the host computer 101 may be, for example, a desktop type personal computer, but is not limited to a desktop type personal computer, and for example, may be a notebook type personal computer, a tablet terminal, a smartphone, or the like.

The CPU 111 is a computer that executes programs and the like that have been stored in the ROM 112 and the external storage device 114. It should be noted that in the first embodiment, by performing processing in accordance with codes of the programs that have been stored in the ROM 112, the CPU 111 is able to execute the functions and processes of the host computer 101, that is, is able to execute respective steps (a control method), etc., which will be described below. The ROM 112 stores an initialization program. The external storage device 114 stores an application program group (a group of application programs), an operating system (an OS), print data generation software, and other various kinds of data. It should be noted that in the first embodiment, Windows (registered trademark) 11 provided by Microsoft (registered trademark) has been installed on the host computer 101 as the OS. The external storage device 114 is not particularly limited, and may be, for example, a hard disk drive (an HDD), a solid state drive (an SSD), or the like. The RAM 113 is used as a working memory or the like when executing various kinds of programs stored in the external storage device 114, and the various kinds of programs become able to run within the host computer 101. The pointing device 117 and the keyboard 118, which are input devices, are connected to the input interface 110. The display unit 119, which is a display device, is connected to the output interface 115. The display unit 119 displays, for example, a scan setting screen 300A, a detailed setting screen (an acceptance screen) 300C, and the like, which will be described below. The NET interface 120 is a network interface, and performs control for performing data transfer with an external device (not shown) via a network (not shown). The scan apparatus 102 is connected to the input/output interface 116. As a result, the host computer 101 becomes capable of communicating with scan apparatuses 102 from a plurality of manufacturers, regardless of the manufacturer of the scan apparatus 102, that is, becomes capable of processing information to and from the scan apparatuses 102 from the plurality of manufacturers. The host computer 101 and the scan apparatus 102 may be connected to each other by wire or wirelessly.

The scan apparatus 102 is an image processing apparatus that includes an image processing unit 190, a CPU 191, a ROM 192, a RAM 193, an operation unit 194, a reading unit 195, a printing unit 196, a NET interface 197, an input/output interface 198, and an external storage device 199. The CPU 191 is a computer that executes programs and the like that have been stored in the ROM 192 and the external storage device 199, and comprehensively controls the scan apparatus 102. The ROM 192 is a memory that stores programs. The RAM 193 is a memory that temporarily stores programs and image data. The operation unit 194 allows various kinds of operation instructions to be issued to the scan apparatus 102. It should be noted that the operation unit 194 is configured to be able to display various kinds of information such as the state of the scan apparatus 102, etc. The reading unit 195 includes a reading function for reading an image of a document. The printing unit 196 prints an image on a sheet based on image data that has been generated by, for example, reading an image of a document by the reading unit 195. It should be noted that the printing unit 196 may be omitted. The NET interface 197 is a network interface, and performs control for performing data transfer with an external device (not shown) via the network (not shown). The host computer 101 is connected to the input/output interface 198. The image data that has been generated by, for example, reading an image of a document by the reading unit 195 is input into the image processing unit 190. In addition, the image processing unit 190 performs various kinds of editing processes with respect to the image data.

The scan apparatus 102 is not particularly limited as long as it is an apparatus including a reading function for reading a document, that is, including a scan function, and may be, for example, an image processing apparatus such as a multifunction peripheral (an MFP) or the like. In addition, the scan apparatus 102 includes a document platen (not shown) and a feeder (not shown). The document platen is a first placement portion, on which one sheet of a document that is an execution target of the reading function is placed. The feeder is a second placement portion disposed at a position different from a position of the document platen, on which a plurality of sheets of a document that are execution targets of the reading function are placed. In addition, in the case of using a multifunction peripheral as the scan apparatus 102, printing performed by the multifunction peripheral is electrophotographic printing in the first embodiment, but is not limited to electrophotographic printing, and may be, for example, inkjet printing or the like.

### Configuration of Scan System Centered on Software

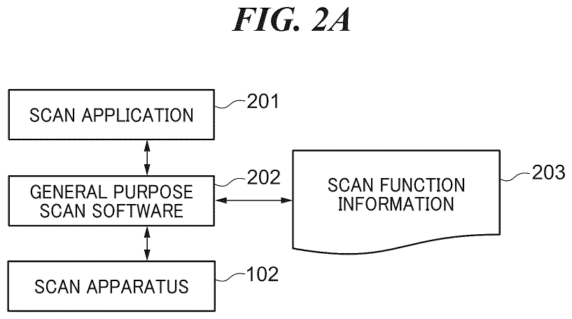

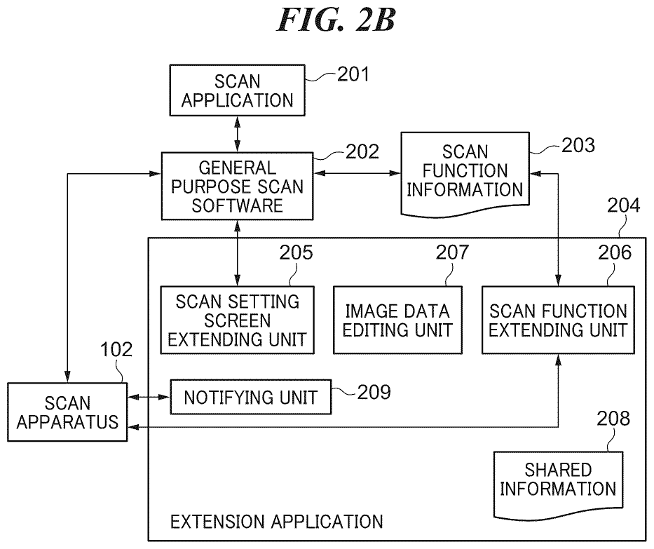

FIG. 2A and FIG. 2B are block diagrams that illustrate software configurations of the scan system. FIG. 2A is a diagram that illustrates a general configuration in the case where an extension application (an application program) 204 has not been associated with general purpose scan software (a standard driver) 202 and the scan apparatus 102. Furthermore, FIG. 2B is a diagram that illustrates a configuration in the case where the extension application 204 has been associated with the general purpose scan software 202 and the scan apparatus 102. The general purpose scan software 202 is a standard driver that is provided by a provider of an OS and has been built into the OS in advance. The standard driver is a class driver (a general purpose program) that is capable of being used, for example, when performing scanning (when performing image reading) in common with respect to the scan apparatuses 102 from the plurality of manufacturers. The standard driver is provided together with the OS as one of the functions included in the package of the OS. The standard driver is capable of performing processing with respect to various types of scan apparatuses by utilizing a standardized scanning method. As a result, the standard driver is able to generate and output instructions that are capable of being interpreted by the scan apparatuses from the plurality of manufacturers. It should be noted that the standard driver is not particularly limited, and for example, may be a program that operates (runs) based on the Internet Printing Protocol (the IPP). The general purpose scan software 202 is installed on (built into) the OS in advance.

The extension application 204 is a program that supports the general purpose scan software 202, that is, a program that assists the general purpose scan software 202 (a program that executes a control method for performing control that supports the general purpose scan software 202). In the first embodiment, the extension application 204 is an extension program that is capable of extending functions that are not capable of being executed by the general purpose scan software 202 with respect to the scan apparatus 102, but is not limited to such an extension program. For example, the extension application 204 may be a program that improves the convenience of functions that are capable of being executed by the general purpose scan software 202 with respect to the scan apparatus 102. The extension application 204 is stored in the external storage device 114 together with, for example, the OS (the general purpose scan software 202). Thus, the host computer 101 includes the general purpose scan software 202 and the extension application 204.

### Configuration in the Case Where the Extension Application Has Not Been Associated With the General Purpose Scan Software and the Scan Apparatus

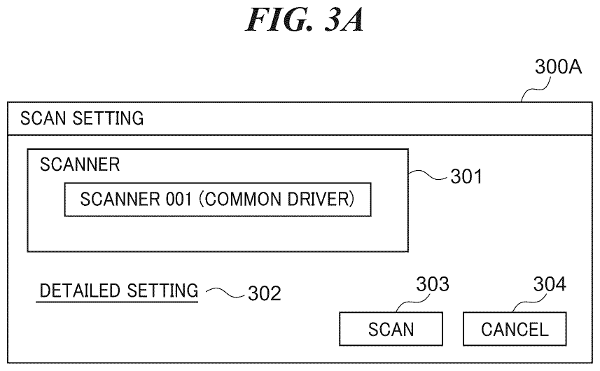

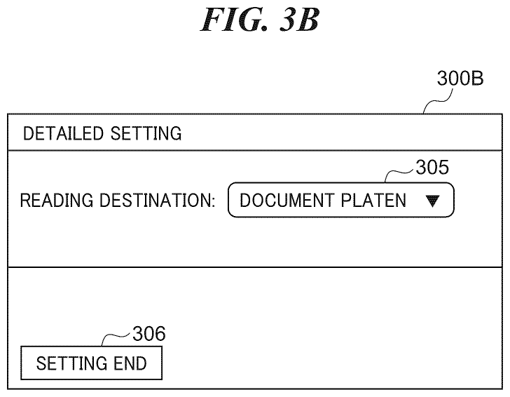

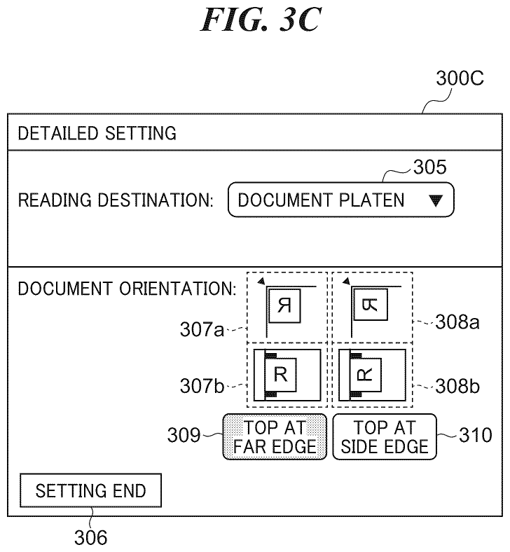

First, the configuration in the case where the extension application 204 has not been associated with the general purpose scan software 202 and the scan apparatus 102 will be described with reference to FIG. 2A. A scan application 201 is software that imports a content (image data) that has been generated by scanning with the scan apparatus 102. The scan application 201 is not particularly limited, and examples of the scan application 201 include, for example, a document creation application, an image editing application, etc. The scan application 201 issues a scan instruction to the OS by receiving a scan request from, for example, the user US1. The scan instruction includes scan setting information for instructing the operations of the general purpose scan software 202 and the scan apparatus 102. In order to issue the scan instruction, the scan application 201 is able to cause the display unit 119 to display the scan setting screen 300A that is provided by any one of the general purpose scan software 202, the OS, and the scan application 201. In addition, when a control 302 (see FIG. 3A) within the scan setting screen 300A is press-operated, it is possible to cause the display unit 119 to display a detailed setting screen 300B (see FIG. 3B) or the detailed setting screen 300C (see FIG. 3C). The scan setting screen 300A, the detailed setting screen 300B, and the detailed setting screen 300C will be described below. The scan setting screen 300A includes setting items indicating scan functions that are capable of being set and control items indicating setting values of the setting items, according to capability information obtained by the general purpose scan software 202, that is, information that is capable of being set as a scan setting. “The capability information” is information about the capabilities of the scan apparatus 102 to perform scanning, etc. In addition, based on this capability information, it is also possible to determine, for example, whether or not information that enables the display of the detailed setting screen 300C is included. As a result of this determination, in the case of being determined that the information that enables the display of the detailed setting screen 300C is included, it is possible to cause to display the detailed setting screen 300C. On the other hand, in the case of being determined that the information that enables the display of the detailed setting screen 300C is not included, the detailed setting screen 300C will not be displayed. In this way, the extension application 204 is able to switch whether or not to display the detailed setting screen 300C depending on the capability information of the scan apparatus 102.

Scan function information 203 is data indicating all scan functions that are capable of being set, setting values of the all scan functions, and scan functions in which exclusive relationships between the setting values and the like have been described. The scan function information 203 is included in a configuration file of the general purpose scan software 202 and is stored in the external storage device 114 as an unchangeable file. Alternatively, the scan function information 203 is dynamically generated by the general purpose scan software 202. Specifically, the general purpose scan software 202 obtains attribute data of the scan apparatus 102 from the scan apparatus 102. The general purpose scan software 202 generates the scan function information 203 in accordance with attribute information within the obtained attribute data. It should be noted that in the case where the scan function information 203 is dynamically generated in this way, it is possible to perform editing with respect to the scan function information 203. In addition, the attribute data of the scan apparatus 102 includes attribute information indicating functions that are capable of being designated in the scan apparatus 102 (attribute information indicating the capabilities of the scan apparatus 102) and setting values related to the attribute information, which are stored in the RAM 113.

With such a configuration, the general purpose scan software 202 allows the user US1 to designate scan functions that are capable of being used in the scan apparatus 102, depending on the scan apparatus 102 connected to the host computer 101. As a result, regardless of the scan apparatus 102, that is, even in the case where a scan apparatus 102 with different functions or a scan apparatus 102 developed by a different scan manufacturer is connected, it becomes possible to designate scan functions that are capable of being used in the scan apparatus 102 with different functions or the scan apparatus 102 developed by the different scan manufacturer. It should be noted that in the first embodiment, it is assumed that the general purpose scan software 202 is a standard class driver that executes scanning based on a standard scan protocol called Mopria. Specifically, as described above, the general purpose scan software 202 is not a unique scan driver depending on the model of the scan apparatus 102, but a standard class driver that is capable of being used in common by the scan apparatuses 102 of various scan manufacturers regardless of the scan manufacturer. In addition, the general purpose scan software 202 obtains the capability information of the scan apparatus 102, and generates the scan function information 203 based on the capability information of the scan apparatus 102 that has been obtained.

In addition, it is possible to associate the general purpose scan software 202 with the extension application 204. As a result, it is possible to execute functions, which are not included in the general purpose scan software 202, with the general purpose scan software 202. For example, when the general purpose scan software 202 causes the scan apparatuses 102 to execute the scan function, the general purpose scan software 202 is not able to execute a start restriction function (a restriction function) that restricts the start of reading (scanning) of a document, that is, that does not allow the start of reading (scanning) of a document. When the user US1 and the user US2 use one scan apparatus 102, there may be a case where the following situation occurs. For example, a timing at which a document is read by the one scan apparatus 102 in response to an operation from the user US1 on the host computer 101 and a timing at which a document is read by the one scan apparatus 102 in response to an operation from the user US2 on the one scan apparatus 102 may overlap. Hereinafter, an instruction to execute the reading function is also referred to as a reading function execution instruction. As described above, the one scan apparatus 102 is capable of being in an overlapping state, in which a plurality of reading function execution instructions (a plurality of instructions to execute the reading function) with respect to the one scan apparatus 102 overlap. In this case, the start restriction function is able to allow one reading function execution instruction (one instruction to execute the reading function) among from the plurality of reading function execution instructions that are in the overlapping state, while restricting the remaining reading function execution instructions (the remaining instructions to execute the reading function). As a result, it is possible to prevent the document of the user US2 from being erroneously read by an operation from the user US1. On the other hand, the general purpose scan software 202 is not a driver that includes the start restriction function. As described above, the general purpose scan software 202 does not support the start restriction function. This is because the start restriction function is a function that is executed independently by the scan apparatus 102 manufactured by a predetermined scan manufacturer. The extension application 204 is able to extend to be capable of executing the function that the general purpose scan software 202 is not able to execute. In the first embodiment, the general purpose scan software 202 is not able to perform (execute) the start restriction function, and the extension application 204 is able to extend to be capable of executing the start restriction function, but the present disclosure is not limited to this. For example, the general purpose scan software 202 may be able to execute a part of the start restriction function, and the extension application 204 may supplement the shortage of the start restriction function to further extend the scope of the execution.

### Configuration in the Case Where the Extension Application Has Been Associated With the General Purpose Scan Software and the Scan Apparatus

The configuration in the case where the extension application 204 has been associated with the general purpose scan software 202 and the scan apparatus 102 will be described with reference to FIG. 2B. As shown in FIG. 2B, unlike FIG. 2A, the extension application 204 is added. In other words, the host computer 101 includes the scan application 201, the general purpose scan software 202, and the scan function information 203, and further includes the extension application 204. The extension application 204 is software for extending the functions of the general purpose scan software 202, and is sometimes simply referred to as “scan software”. It should be noted that the extension application 204 is software that is not included in the OS in advance (is not bundled with the OS). Therefore, the extension application 204 is downloaded from a server (not shown) via the Internet by the user US1 operating the host computer 101, and is installed on the host computer 101. Alternatively, when the scan apparatus 102 is connected to the host computer 101, the extension application 204 may be automatically installed on the host computer 101 based on this connection. Specifically, in the case where the scan apparatus 102 is connected to the host computer 101, the OS obtains device identification information from the scan apparatus 102. The OS may download the extension application 204 corresponding to the obtained device identification information from the server via the Internet and then install the downloaded extension application 204. As a result, the general purpose scan software 202 and the extension application 204 are retained in the host computer 101 as separate control programs. It should be noted that the general purpose scan software 202 and the extension application 204 may be updated and upgraded, respectively. In this case, an update processing of the general purpose scan software 202 and an update processing of the extension application 204 may be performed at the same timing or at different timings. In addition, a trigger for the host computer 101 to obtain the general purpose scan software 202 and a trigger for the host computer 101 to obtain the extension application 204 may be the same trigger or may be different triggers. In addition, in the case where the extension application 204 has been installed, the OS associates the extension application 204 with the general purpose scan software 202 and the scan apparatus 102.

As shown in FIG. 2B, the extension application 204 is capable of exchanging information with the general purpose scan software 202 and the scan apparatus 102, respectively, that is, the extension application 204 is capable of transmitting and receiving information to and from the general purpose scan software 202 and the scan apparatus 102, respectively. In other words, the extension application 204 is associated with the general purpose scan software 202 and the scan apparatus 102. In the first embodiment, the extension application 204 includes a scan setting screen extending unit 205, a scan function extending unit 206, an image data editing unit 207, and a notifying unit 209. In addition, the extension application 204 includes shared information 208 that is capable of being accessed from each unit of the scan setting screen extending unit 205, the scan function extending unit 206, the image data editing unit 207, and the notifying unit 209. The shared information 208 is a file that has been stored in the external storage device 114 or information that has been stored in the RAM 113. The extension application 204 is able to perform writing and reading of the shared information 208 by using an application program interface (an API) provided by the OS.

It should be noted that the extension application 204 may end the operation of the extension application 204 as a whole when the processing of one of the scan setting screen extending unit 205, the scan function extending unit 206, the image data editing unit 207, and the notifying unit 209 ends. In this case, the OS starts up the extension application 204 every time the OS receives a processing execution request from one of the scan setting screen extending unit 205, the scan function extending unit 206, the image data editing unit 207, and the notifying unit 209. In addition, the extension application 204 may cancel the processing of one of the scan setting screen extending unit 205, the scan function extending unit 206, the image data editing unit 207, and the notifying unit 209 during the processing of one of the scan setting screen extending unit 205, the scan function extending unit 206, the image data editing unit 207, and the notifying unit 209. In this case, a job being processed in a print queue is deleted by the OS. As described above, the scan application 201 issues a scan instruction to the OS upon receiving a scan request from the user US1. In addition, the scan application 201 is able to cause to display a scan setting screen. In the configuration shown in FIG. 2B, the scan application 201 is able to cause to display the scan setting screen 300A (the detailed setting screen 300C) provided by the scan setting screen extending unit 205 (the extension application 204). In addition, the scan setting screen extending unit 205 is able to save (store), in the shared information 208, a detailed setting that has been set by the user US1.

The image data editing unit 207 obtains image data from the scan apparatus 102. In addition, after obtaining the image data, the image data editing unit 207 is also able to edit the obtained image data. In addition, the image data editing unit 207 obtains detailed setting information from the shared information 208, and performs image editing on the image data in accordance with the detailed setting information. The extension application 204 may perform image editing on the image data, which has been obtained by the general purpose scan software 202, in accordance with the detailed setting information.

The scan function extending unit 206 is able to edit the scan function information 203 that has been generated by the general purpose scan software 202 or the OS. As a result, it is possible to perform the addition of functions provided by the extension application 204. In addition, it is also possible to perform the addition of the functions that are capable of being executed by the scan apparatus 102 but are not capable of being executed by the general purpose scanning software 202 (for example, the start restriction function, a document orientation designation function, etc.), the addition of the exclusive relationships between the setting values of the scan functions, and the like. The OS starts up the scan function extending unit 206 when the extension application 204 has been first associated with the scan apparatus 102 and the general purpose scan software 202. In addition, the OS may start up the scan function extending unit 206 at another timing (for example, when the OS is started up). With such startup, even in the case where a scanning-related function is extended later, the scan function extending unit 206 is able to detect the extended scanning-related function and add the detected scanning-related function to the scan function information 203.

The notifying unit 209 is able to, when an error occurs in the scan apparatus 102, notify that the error occurs in the scan apparatus 102. For example, in the case where a reading jam error occurs in the scan apparatus 102, the general purpose scan software 202 detects the occurrence of this reading jam error. By using a notifying function called a toast notification, which is one of the functions of the OS, the OS causes the display unit 119 to display the occurrence of the reading jam error, which is a detection result obtained by the general purpose scan software 202, as a message. It should be noted that when the user US1 operates the toast notification, the notifying unit 209 is invoked by the OS, and a user interface screen (a UI screen) of the notifying unit 209 is displayed. On the user interface screen, for example, a detailed message regarding the reading jam error, a method for clearing the jam, etc. are capable of being displayed.

As described above, in the first embodiment, it can be said that the extension application 204 includes the following four functions. The first function is a function to display a setting screen. The first function is executed by the scan setting screen extending unit 205. The second function is a function to edit the image data in accordance with the detailed setting information. The second function is executed by the image data editing unit 207. The third function is a function to extend the functions that are capable of being designated by image data generation software. The third function is executed by the scan function extending unit 206. The fourth function is a function to display a screen in response to the occurrence of an error in the scan apparatus 102. The fourth function is executed by the notifying unit 209. It should be noted that the configuration of the extension application 204 is not limited to the configuration having these four functions, and it is preferable that the configuration of the extension application 204 is a configuration having at least one function of these functions, and the configuration of the extension application 204 may also have other functions.

### Examples of the Scan Setting Screen/the Detailed Setting Screen

FIG. 3A, FIG. 3B, and FIG. 3C are diagrams that illustrate examples of screens displayed on the display unit of the scan system. FIG. 3A illustrates a scan setting screen displayed by the scan application 201. FIG. 3B illustrates a detailed setting screen that is displayed in the case of the configuration in which the extension application 204 has not been associated. FIG. 3C illustrates a detailed setting screen that is displayed in the case of the configuration in which the extension application 204 has been associated. It should be noted that the unit or the module that displays each screen is not particularly limited. For example, the scan setting screen extending unit 205 may be configured to only generate a display screen. In this case, the scan setting screen extending unit 205 transmits the generated display screen to the scan application 201 via the general purpose scan software 202. The scan application 201 may be configured to display the obtained display screen.

The scan setting screen 300A shown in FIG. 3A is a screen on which a setting related to scanning performed by the scan apparatus 102 is capable of being performed. The scan setting screen 300A includes a control (a button) 301, the control 302, a control 303, and a control 304. By using the control 301, it is possible to select and set a scanner apparatus to be used for reading a document. In FIG. 3A, as an example, the scanner apparatus to be used for reading a document is set to “scanner 001 (common driver)”. By using the control 302, it is possible to cause to display a screen on which a detailed setting related to scanning is capable of being performed. By using the control 303, it is possible to instruct the scan apparatus 102 to start scanning. By using the control 304, it is possible to instruct the scan apparatus 102 to cancel scanning.

In the case of the configuration in which the extension application 204 has not been associated, by operating the control 302, the detailed setting screen 300B shown in FIG. 3B is displayed. The detailed setting screen 300B includes a control 305 and a control 306. The control 305 is a placement portion selecting section that is used to select and set a reading destination of a document in the scan apparatus 102, that is, a placement portion on which a document to be read is placed. As described above, the scan apparatus 102 includes the document platen (a document platen glass) and the feeder as the reading destination of the document. In this case, by using the control 305 shown in FIG. 3B, as an example, “document platen” is selected. By using the control 306, it is possible to end the setting performed by the control 305. In addition, by operating the control 306, returning to the scan setting screen 300A shown in FIG. 3A.

In the case of the configuration in which the extension application 204 has been associated, by operating the control 302, the detailed setting screen 300C shown in FIG. 3C is displayed. In addition, the detailed setting screen 300C is an acceptance screen for accepting information required for causing the scan apparatus 102 to execute the reading function. The detailed setting screen 300C is a screen that is displayed together with the scan setting screen 300A, but the display format thereof is not particularly limited. For example, the detailed setting screen 300C may be displayed overlapping the scan setting screen 300A. Furthermore, the detail setting screen 300C may be displayed adjacent to the scan setting screen 300A, or the scan setting screen 300A may disappear once and then the detail setting screen 300C may be displayed. Similar to the detailed setting screen 300B, the detailed setting screen 300C includes the control 305 and the control 306. In addition, the detailed setting screen 300C includes a control 309 and a control 310. By using (operating) one of the control 309 and the control 310, it is possible to set an orientation of a document to be read on the placement portion on which the document to be read is placed. In the case of placing a document to make the orientation of the document on the placement portion become that the top edge of the document is at the far edge, the control 309 is operated. A document image 307a indicates a state where a document is placed on the document platen so that the top edge of the document is at the far edge and the printed side of the document faces downward. A document image 307b indicates a state where a document is placed on the feeder so that the top edge of the document is at the far edge and the printed side of the document faces downward. In addition, in the case of placing a document to make the orientation of the document on the placement portion become that the top edge of the document is at the side edge, the control 310 is operated. A document image 308a indicates a state where a document is placed on the document platen so that the top edge of the document is at the side edge and the printed side of the document faces downward. A document image 308b indicates a state where a document is placed on the feeder so that the top edge of the document is at the side edge and the printed side of the document faces downward. It should be noted that the state shown in FIG. 3C is a state where the control 309 has been selected.

Here, the reason why the items included in the detailed setting screen 300B shown in FIG. 3B are different from the items included in the detailed setting screen 300C shown in FIG. 3C will be described. In other words, the reason why it is possible to switch between displaying the detailed setting screen 300B and displaying the detailed setting screen 300C will be described. The detailed setting screen 300B and the detailed setting screen 300C are each generated based on the scan function information (the capability information). The general purpose scan software 202 does not support the document orientation designation function. Therefore, it is not possible to add the document orientation designation function to the scan function information 203 by using only the general purpose scan software 202. In addition, even in the case where the scan function information 203 originally includes the document orientation designation function, the general purpose scan software 202 is not able to interpret the document orientation designation function that is included in the scan function information 203. Therefore, it is not possible to display items related to the document orientation designation function on the detailed setting screen. Therefore, the scan function extending unit 206 adds the document orientation designation function to the scan function information 203. Furthermore, the scan setting screen extending unit 205 refers to the capability information and then causes to display the detailed setting screen 300C. This detailed setting screen 300C is a screen corresponding to the document orientation designation function. It should be noted that the detailed setting screen 300C may additionally include setting item(s) for the document orientation designation function.

### Flowchart of the Scan Function Extending Unit That Edits the Scan Function Information

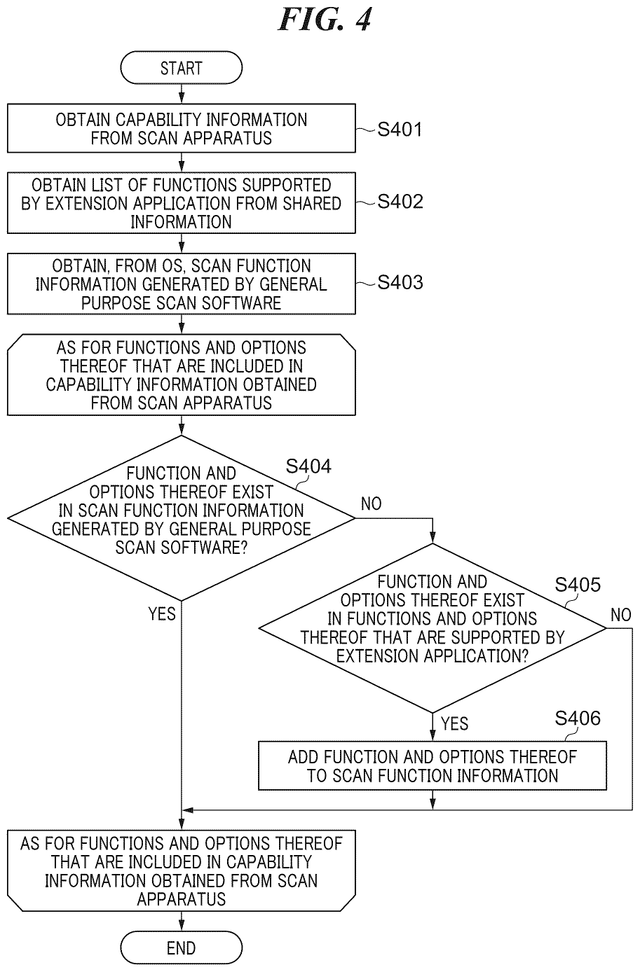

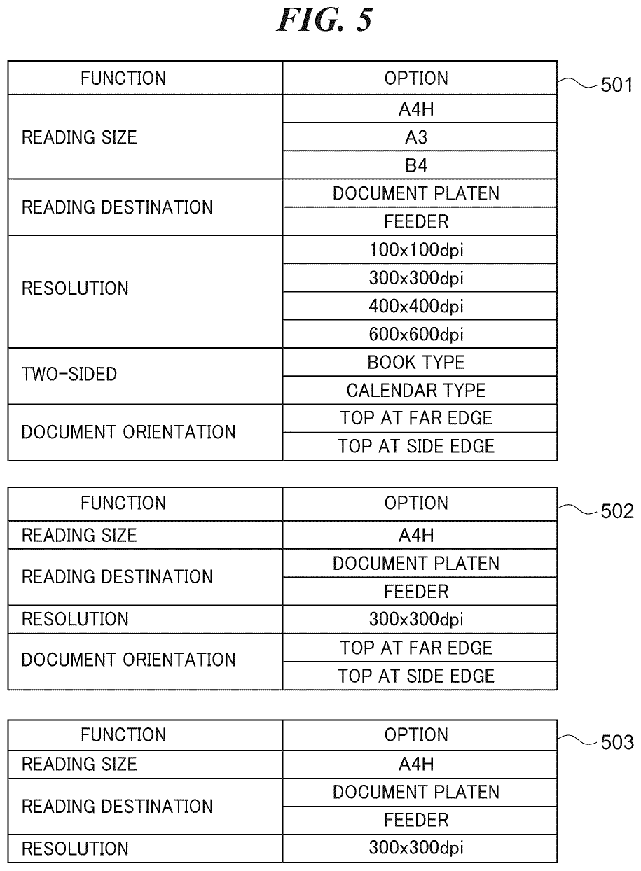

FIG. 4 is a flowchart that illustrates a processing in which the scan function extending unit edits the scan function information. It should be noted that a program, which is based on the flowchart shown in FIG. 4, is executed by the CPU 111 controlling the scan function extending unit 206. FIG. 5 is a diagram that illustrates examples of a list table of scan information. As shown in FIG. 4, in a step S401, the scan function extending unit 206 obtains the capability information from the scan apparatus 102. The capability information is information relating to the capability to execute a scan function, and in the first embodiment, the capability information includes the attribute information indicating the functions that are capable of being designated in the scan apparatus 102 and the setting values related to the attribute information. A table 501 shown in FIG. 5 indicates a list of the capability information that has been obtained from the scan apparatus 102. As shown in the table 501, it is possible from the scan apparatus 102 to obtain various kinds of functions such as the document orientation designation function, and options that are capable of being set for the various kinds of functions. For example, in the document orientation designation function, options thereof are “top at far edge” in which a document is placed on the placement portion so that the top edge of the document is at the far edge, and “top at side edge” in which a document is placed on the placement portion so that the top edge of the document is at the side edge.

In a step S402, the scan function extending unit 206 obtains the scan functions supported by the extension application 204 from the shared information 208. A list of the scan functions supported by the extension application 204 is stored in the shared information 208. A table 502 shown in FIG. 5 includes all scan functions that are capable of being executed by the extension application 204 (all scan functions that are capable of being supported by the extension application 204) and setting values thereof. For example, in the document orientation designation function, options thereof are “top at far edge” in which a document is placed on the placement portion so that the top edge of the document is at the far edge, and “top at side edge” in which a document is placed on the placement portion so that the top edge of the document is at the side edge. It should be noted that the scan functions that are capable of being executed by the extension application 204 may be updated by, for example, updating the extension application 204.

In a step S403, the scan function extending unit 206 obtains the scan function information 203, which has been created by the general purpose scan software 202, from the OS. The scan function information 203 is created based on the capability information, which has been obtained by the general purpose scan software 202 from the scan apparatus 102. The scan function information 203 created by the general purpose scan software 202 includes only the scan functions that are capable of being executed by the general purpose scan software 202 out of the capability information obtained from the scan apparatus 102. A table 503 shown in FIG. 5 includes all scan functions that are capable of being executed by the general purpose scan software 202 and setting values thereof. As shown in the table 503, the scan functions that are capable of being executed by the general purpose scan software 202 do not include the document orientation designation function. Therefore, the scan function information 203 does not include information about the document orientation designation function. The scan function extending unit 206 adds functions and options thereof to the scan function information 203, which enables the extension application 204 to compensate for insufficient functions of the general purpose scan software 202. In addition, the scan function extending unit 206 is also able to delete unnecessary functions and options thereof from the scan function information 203 created by the general purpose scan software 202.

Steps S404, S405, and S406 are processes that are repeatedly performed for the list of the functions included in the capability information that has been obtained from the scan apparatus 102 in the step S401. In the first embodiment, the steps S404, S405, and S406 are repeatedly performed for thirteen options in total that are included in the table 501.

In the step S404, the scan function extending unit 206 determines whether or not the function currently being processed and options thereof exist in the scan function information 203 that has been generated by the general purpose scan software 202. As a result of the determination in the step S404, in the case of being determined that the function currently being processed and options thereof exist in the scan function information 203, if the last item in the options is being processed, the processing ends. Alternatively, if the last item in the options is not being processed, the next item in the options is selected and the step S404 is executed again. On the other hand, as the result of the determination in the step S404, in the case of being determined that the function currently being processed and options thereof do not exist in the scan function information 203, the processing proceeds to the step S405. For example, in the first embodiment, the table 501 includes the reading destination “document platen”, and the table 503 also includes the reading destination “document platen”. In this case, in the step S404, it is determined that the function currently being processed and options thereof exist in the scan function information 203. On the other hand, the table 501 includes “top at far edge” of the document orientation designation function, but the table 503 does not include “top at far edge” of the document orientation designation function. In this case, in the step S404, it is determined that the function currently being processed and options thereof do not exist in the scan function information 203.

In the step S405, the scan function extending unit 206 determines whether or not the function currently being processed (and options thereof) exist in the functions (and options thereof) supported by the extension application 204. As a result of the determination in the step S405, in the case of being determined that the function currently being processed (and options thereof) exist in the functions (and options thereof) supported by the extension application 204, the processing proceeds to the step S406. On the other hand, as the result of the determination in the step S405, in the case of being determined that the function currently being processed (and options thereof) do not exist in the functions (and options thereof) supported by the extension application 204, as in the case of being determined “YES” in the step S404, if the last item in the options is being processed, the processing ends. Alternatively, if the last item in the options is not being processed, the next item in the options is selected and the step S404 is executed again. For example, in the first embodiment, in the case where the document orientation designation function as the function currently being processed is “top at far edge”, the “top at far edge” also exists in the table 502. Therefore, it is determined in the step S405 that the function currently being processed (and options thereof) exist in the functions (and options thereof) supported by the extension application 204.

In the step S406, the scan function extending unit 206 adds the function currently being processed (and options thereof) to the scan function information 203. After the step S406 is executed, as in the case of being determined “YES” in the step S404, if the last item in the options is being processed, the processing ends. Alternatively, if the last item in the options is not being processed, the next item in the options is selected and the step S404 is executed again.

As described above, the extension application 204 is able to add, to the scan function information 203, the functions (and options thereof) that are not supported by the general purpose scan software 202, that are capable of being supported by the scan apparatus 102, and that are capable of being supported by the extension application 204. Then, the capability information is generated based on the scan function information 203 that has been edited by this adding process. Furthermore, the scan setting screen extending unit 205 is able to generate a display screen based on this capability information, thereby extending the functions that are not supported by the general purpose scan software 202, and displaying the detailed setting screen 300C.

### Processes After the Scan Application Accepts Scan Setting

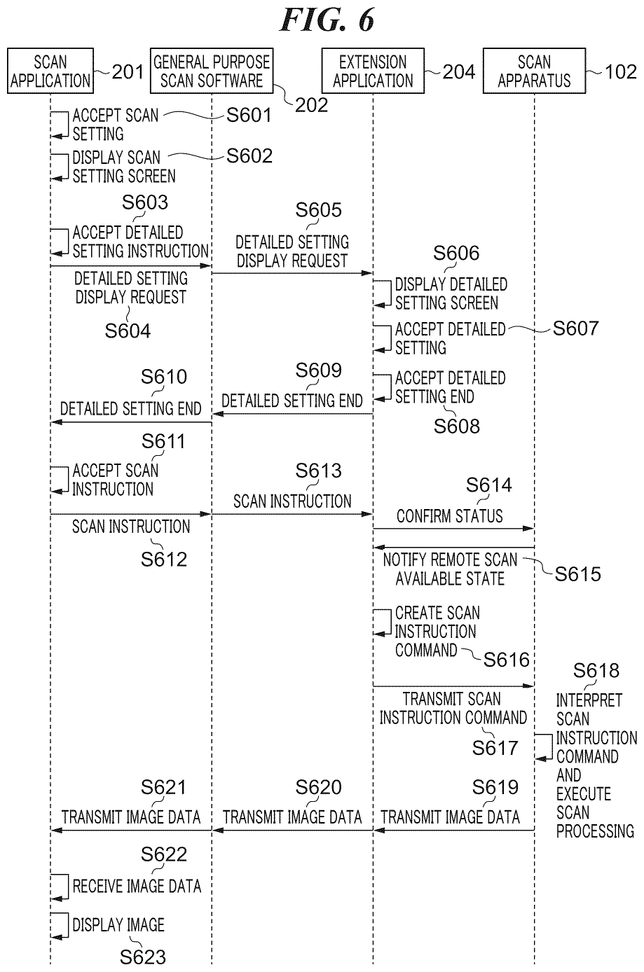

FIG. 6 is a sequence diagram that illustrates processes executed between the scan application, the general purpose scan software, the extension application, and the scan apparatus after the scan application accepts a scan setting. The processes in the scan application 201, the general purpose scan software 202, and the extension application 204 are executed by the CPU 111 of the host computer 101. This processing program has been stored in the external storage device 114. Furthermore, the CPU 111 loads the processing program from the external storage device 114 into the RAM 113 and executes the processing program. In addition, the processes in the scan apparatus 102 are executed by the CPU 191 of the scan apparatus 102. This processing program has been stored in the external storage device 199. Furthermore, the CPU 191 loads the processing program from the external storage device 199 into the RAM 193 and executes the processing program. It should be noted that the processes in the scan apparatus 102 may be executed by the CPU 111 via the CPU 191. In addition, the software configuration of the scan system 1000 is the software configuration shown in FIG. 2B.

As shown in FIG. 6, in a step S601, the scan application 201 accepts a scan setting from the user US1. The user US1 is able to operate, for example, the pointing device 117 or the keyboard 118 to instruct the scan application 201 on the scan setting.

In a step S602, the scan application 201 displays the scan setting screen 300A shown in FIG. 3A on the display unit 119.

In a step S603, the scan application 201 accepts a detailed setting instruction from the user US1. The user US1 is able to instruct a detailed setting by, for example, operating the pointing device 117 or the keyboard 118 to select the control 302 on the scan setting screen 300A.

In a step S604, the scan application 201 makes a detailed setting display request with respect to the general purpose scan software 202.

In a step S605, the general purpose scan software 202 makes the detailed setting display request with respect to the extension application 204.

In a step S606, the scan setting screen extending unit 205 of the extension application 204 displays the detailed setting screen 300C shown in FIG. 3C on the display unit 119 in response to the detailed setting display request received in the step S605 (a display control step). This display control step is executed prior to a determining step that will be described below. As described above, the scan function extending unit 206 adds, to the scan function information 203, the start restriction function described above, the document orientation designation function described above, and the like. The scan setting screen extending unit 205 is able to display the detailed setting screen 300C by referring to the capability information that has been generated based on the scan function information 203 to which these functions have been added. It should be noted that, for example, in the case where there are setting items for a resolution of an image and the like, these setting items may be displayed as needed, or these setting items may be suppressed from being displayed or may be grayed out.

In a step S607, the scan setting screen extending unit 205 accepts a detailed setting made by the user US1 on the detailed setting screen 300C. Here, as an example, it is assumed that on the detailed setting screen 300C, the control 309 has been selected from the control 309 and the control 310 in a state where the reading destination “document platen” has been selected by the control 305 (see FIG. 3C). Thereafter, the control 306 on the detailed setting screen 300C is press-operated. It should be noted that, by this pressing operation, a setting state on the detailed setting screen 300C is stored in the RAM 113.

In a step S608, the scan setting screen extending unit 205 accepts that the detailed setting made by the user US1 has ended based on the operation of the control 306 performed in the step S607. It should be noted that the user US1 is able to instruct to end the detailed setting by, for example, operating the pointing device 117 or the keyboard 118 to select the control 306. As a result, the setting state on the detailed setting screen 300C is written to the scan function information 203. It should be noted that the information to be written to the scan function information 203 may also include, for example, the above-described information that is suppressed from being displayed or is grayed out.

In a step S609, the extension application 204 transmits, to the general purpose scan software 202, detailed setting end information indicating that the detailed setting has been ended in the step S608.

In a step S610, the general purpose scan software 202 receives the detailed setting end information that has been transmitted from the extension application 204 in the step S609. Then, the general purpose scan software 202 transmits this detailed setting end information to the scan application 201.

In a step S611, the scan application 201 accepts a scan instruction from the user US1. The user US1 is able to issue the scan instruction, that is, an instruction to read a document (a document reading instruction), by operating, for example, the pointing device 117 or the keyboard 118 to select the control 303 on the scan setting screen 300A (see FIG. 3A).

In a step S612, the scan application 201 issues the scan instruction that has been accepted in the step S611 to the general purpose scan software 202.

In a step S613, the general purpose scan software 202 accepts the scan instruction that has been issued in the step S612. Then, the general purpose scan software 202 issues this scan instruction to the extension application 204.

In a step S614, the extension application 204 confirms (checks), with respect to the scan apparatus 102, a status indicating whether an instruction to start the execution of the reading function from the host computer 101 (the CPU 111) is allowed or not, that is, a status indicating whether an instruction to start the execution of the reading function from the host computer 101 (the CPU 111) is permitted or not. Hereinafter, the execution of the reading function from the host computer 101 will be referred to as “a remote scan”.

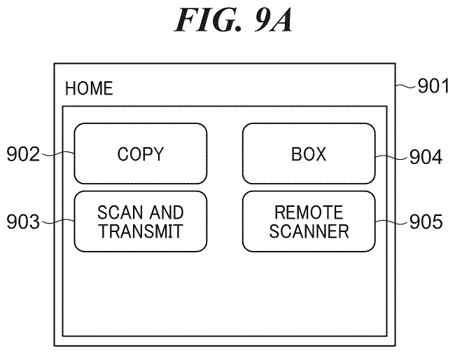

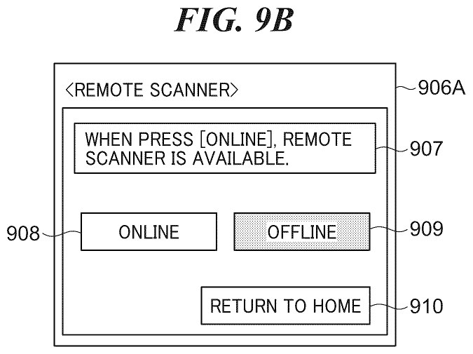

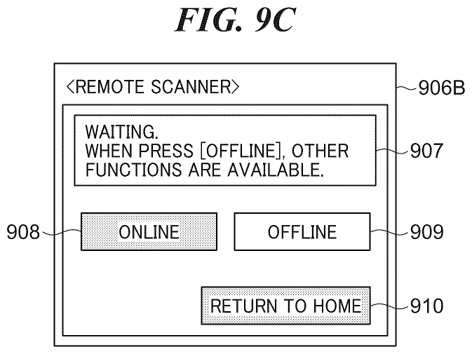

In a step S615, in the case where the scan apparatus 102 is in a state where the remote scan is available as a result of (in response to) the status confirmation (the status check) performed in the step S614, the scan apparatus 102 notifies the extension application 204 that the scan apparatus 102 is in the state where the remote scan is available, that is, the scan apparatus 102 notifies the extension application 204 of a remote scan available state. As a result, the extension application 204 is able to obtain, from the scan apparatus102, information indicating that the scan apparatus 102 is in the remote scan available state, as a status (state information) relating to the state of the scan apparatus 102 (an obtaining step). It should be noted that the determination in the step S615 as to whether the scan apparatus 102 is in the remote scan available state or not is made based on a setting state on a setting screen 906B (see FIG. 9C) that will be described below. In addition, the operation before the setting screen 906B is displayed is performed, for example, when the user US1 places a document on the document platen of the scan apparatus 102.

In a step S616, the extension application 204 creates a scan instruction command based on the scan function information 203 to which the setting state on the detailed setting screen 300C has been written in the step S608. In addition, there is a case where the above-described information that is suppressed from being displayed or is grayed out has not been written to the scan function information 203 in the step S608. In this case, in the step S616, the extension application 204 may add, to the scan instruction command, the information that has not been written to the scan function information 203, or may set the information that has not been written to the scan function information 203 as default value(s).

In a step S617, the extension application 204 transmits, to the scan apparatus 102, the scan instruction command that has been created in the step S616. As a result, the execution of a remote scan is instructed to the scan apparatus 102 (an instructing step).

In a step S618, the input/output interface 198 of the scan apparatus102 receives the scan instruction command that has been transmitted in the step S617. Then, the reading unit 195 of the scan apparatus102 analyzes (interprets) the scan instruction command. Based on this analysis result (this interpretation result), the reading unit 195 executes scanning under the setting condition on the detailed setting screen 300C. As a result, scanned image data (read image data) of a document is obtained.

In a step S619, the input/output interface 198 of the scan apparatus102 transmits, to the extension application 204, the image data (the scanned image data) that has been obtained in the step S618.

In a step S620, the extension application 204 receives the image data that has been transmitted in the step S619. Then, the extension application 204 transmits this image data to the general purpose scan software 202.

In a step S621, the general purpose scan software 202 receives the image data that has been transmitted in the step S620. Then, the general purpose scan software 202 transmits this image data to the scan application 201.

In a step S622, the scan application 201 receives the image data that has been transmitted in the step S621.

In a step S623, the scan application 201 causes the display unit 119 to display the image data that has been received in the step S622. As a result, the image data of a document is displayed as a preview image on the display unit 119.

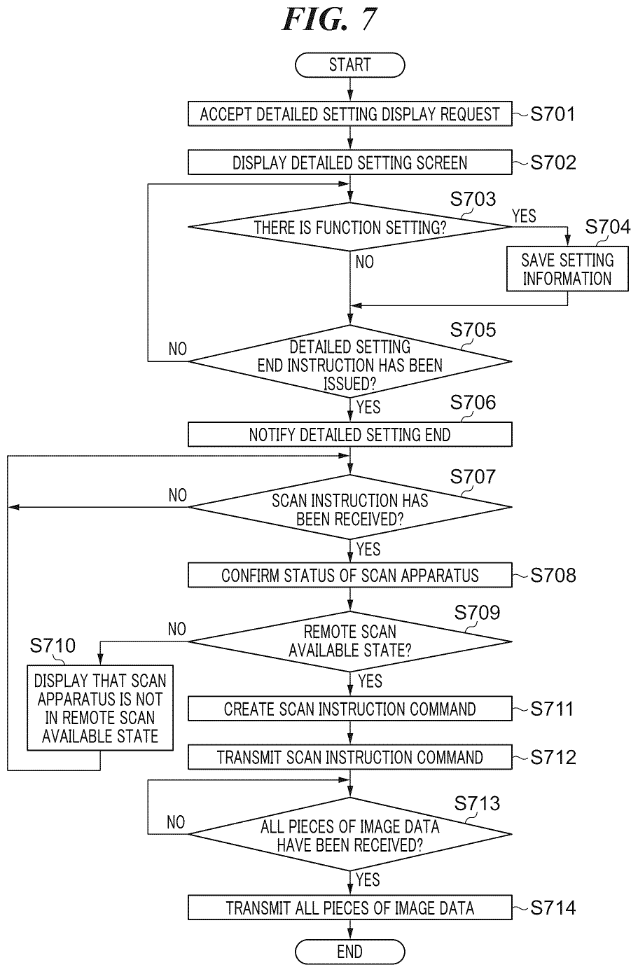

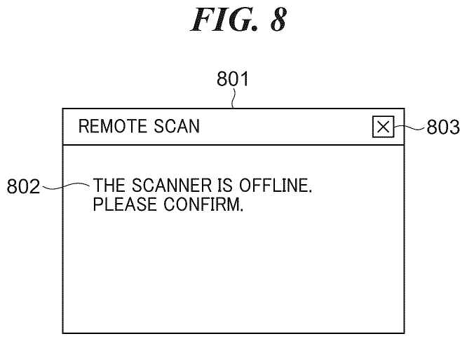

FIG. 7 is a flowchart that illustrates a processing executed by the extension application. A program based on the flowchart illustrated in FIG. 7 is stored in the external storage device 114. The CPU 111 is able to execute the program by loading the program from the external storage device 114 into the RAM 113. FIG. 8 is a diagram that illustrates an example of a screen displayed on the display unit of the scan system in a step S710 of the flowchart illustrated in FIG. 7. As shown in FIG. 7, in a step S701, the extension application 204 accepts the detailed setting display request (see the step S605) from the general purpose scan software 202.

In a step S702, the scan setting screen extending unit 205 of the extension application 204 displays the detailed setting screen 300C shown in FIG. 3C on the display unit 119 in response to the detailed setting display request that has been accepted in the step S701 (see the step S606). As described above, the start restriction function, the document orientation designation function, and the like are added to the scan function information 203. The scan setting screen extending unit 205 is able to display the detailed setting screen 300C by referring to the capability information that has been generated based on this scan function information 203.

In a step S703, the scan setting screen extending unit 205 determines whether or not the detailed setting on the detailed setting screen 300C has been performed, that is, whether or not a selection by the control 305 and a selection with respect to the control 309 and the control 310 have been made. As a result of the determination in the step S703, in the case of being determined that the detailed setting on the detailed setting screen 300C has been performed, the processing proceeds to a step S704. On the other hand, as the result of the determination in the step S703, in the case of being determined that the detailed setting on the detailed setting screen 300C has not been performed, the processing proceeds to a step S705.

In the step S704, the scan setting screen extending unit 205 stores (saves) the setting state on the detailed setting screen 300C (setting information) in the RAM 113. After the step S704 is executed, the processing proceeds to the step S705.

In the step S705, the scan setting screen extending unit 205 determines whether or not an instruction to end the detailed setting (a detailed setting end instruction) on the detailed setting screen 300C (see the step S608) has been issued, that is, whether or not an operation with respect to the control 306 has been performed. As a result of the determination in the step S705, in the case of being determined that the detailed setting end instruction on the detailed setting screen 300C has been issued, the processing proceeds to a step S706. On the other hand, as the result of the determination in the step S705, in the case of being determined that the detailed setting end instruction on the detailed setting screen 300C has not been issued, the processing returns to the step S703, and the subsequent steps are executed in sequence.

In the step S706, the extension application 204 notifies the general purpose scan software 202 of the end of the detailed setting in the step S705 (see the step S609).

In a step S707, the extension application 204 determines whether or not the scan instruction has been received from the general purpose scan software 202 (see the step S613). As a result of the determination in the step S707, in the case of being determined that the scan instruction has been received from the general purpose scan software 202, the processing proceeds to a step S708. On the other hand, as the result of the determination in the step S707, in the case of being determined that the scan instruction has not been received from the general purpose scan software 202, the processing remains in the step S707 and waits.

In the step S708, the extension application 204 confirms (checks), with respect to the scan apparatus 102, a status indicating whether an instruction to start the remote scan is allowed or not (see the step S614).

In a step S709, the extension application 204 determines whether or not the scan apparatus 102 is in the remote scan available state, based on the notification (see the step S615) from the scan apparatus 102 (the determining step). As a result of the determination in the step S709, in the case of being determined that the scan apparatus 102 is in the remote scan available state, the processing proceeds to a step S711. On the other hand, as the result of the determination in the step S709, in the case of being determined that the scan apparatus 102 is not in the remote scan available state, the processing proceeds to the step S710.

In the step S710, the extension application 204 notifies, that is, informs, by the notifying unit 209, that the scan apparatus 102 is not in the remote scan available state (an informing step). In this case, a notification screen 801 shown in FIG. 8 is displayed on the display unit 119 of the host computer 101. The notification screen 801 includes a message 802 and a control 803. The message 802 is a message saying, “The current scan apparatus 102 is offline and therefore not in a remote scan available state. Please confirm again.”. By press-operating the control 803, the notification screen 801 is closed. After the step S710 is executed, the processing returns to the step S707, and the subsequent steps are executed in sequence.

In the step S711, the extension application 204 creates a scan instruction command based on the scan function information 203 to which the setting state on the detailed setting screen 300C has been written (see the step S616). In addition, as a method for creating a scan instruction command, for example, there is a method for extending a command of a standard protocol. Furthermore, as this extension method, for example, there is a method of describing a dedicated command in an extension area of the command of the standard protocol. Other extension methods include, for example, a method in which a command based on a unique standard is added to the end of a command of a standard protocol, or a method in which the extension application 204 overwrites a command of a standard protocol with a unique command system. In addition, in the case of issuing an instruction from the extension application 204, the instruction and communication may be performed by using a manufacturer's unique protocol, regardless of the standard protocol.

In a step S712, the extension application 204 transmits, to the scan apparatus 102, the scan instruction command that has been created in the step S711 (see the step S617).

In a step S713, the extension application 204 determines whether or not all pieces of the image data (see the step S619) from the scan apparatus 102 have been received. As a result of the determination in the step S713, in the case of being determined that all pieces of the image data from the scan apparatus 102 have been received, the processing proceeds to a step S714. On the other hand, as the result of the determination in the step S713, in the case of being determined that all pieces of the image data from the scan apparatus 102 have not been received, the processing remains in the step S713 and waits.

In the step S714, the extension application 204 transmits, to the general purpose scan software 202, all pieces of the scanned image data (all pieces of the image data) from the scan apparatus 102 that have been determined in the step S713 (see the step S620). After the step S714 is executed, the processing ends.

FIG. 9A, FIG. 9B, and FIG. 9C are diagrams that illustrate examples of screens displayed on the display unit of the scan system. A home screen 901 shown in FIG. 9A, a setting screen 906A shown in FIG. 9B, and a setting screen 906B shown in FIG. 9C are all displayed on a display unit 188 of the scan apparatus 102. As shown in FIG. 9A, the home screen 901 includes a control 902, a control 903, a control 904, and a control 905. The control 902 is selected in the case of executing a copy function of the scan apparatus 102. The control 903 is selected in the case of executing a transmitting function of the scan apparatus 102. The control 904 is selected in the case of executing a box function of the scan apparatus 102. The control 905 is selected in the case of executing a remote scan function of the scan apparatus 102.

The setting screen 906A shown in FIG. 9B is displayed in the case where the control 905 has been selected. The setting screen 906A includes a message 907, a control 908, a control 909, and a control 910. The message 907 is a message about an operation method for putting the scan apparatus 102 into a state in which the scan apparatus 102 accepts a remote scan instruction (hereinafter, referred to as “a remote scan instruction acceptance state”). The control 908 is selected in the case of putting the scan apparatus 102 into an online state. By press-operating the control 908, the setting screen 906A changes to the setting screen 906B shown in FIG. 9C. The control 909 is selected in the case of putting the scan apparatus 102 into an offline state. By press-operating the control 909, it is possible to cancel the remote scan instruction acceptance state of the scan apparatus 102. In an initial state (a default state) of the setting screen 906A, the control 909 has been selected in advance. The control 910 is selected in the case of returning to the home screen 901.

The setting screen 906B shown in FIG. 9C is a setting screen in which the scan apparatus 102 is set to the acceptance state in which the scan apparatus 102 accepts a remote scan instruction. On the setting screen 906B, the control 908 is displayed inverted from white to black. In addition, the message 907 is a message about an operation method for releasing the scan apparatus 102 from the remote scan instruction acceptance state (cancelling the remote scan instruction acceptance state of the scan apparatus 102) and making other functions available. The control 910 is grayed out. This prevents the screen from returning to the home screen 901, thereby preventing the controls 902 to 904 other than the control 905 from being selected. In the case where such a setting screen 906B is displayed, in the step S615 of the flowchart shown in FIG. 6, it is possible to obtain information displayed on the setting screen 906B, that is, setting information indicating that the scan apparatus 102 has been set to the remote scan instruction acceptance state, as a status. As a result, the extension application 204 is able to execute the start restriction function.

As described above, in the scan system 1000, there is a case where a timing at which a document is read by the scan apparatus 102 in response to an operation from the user US1 and a timing at which a document is read by the scan apparatus 102 in response to an operation from the user US2 overlaps. In such a case, the extension application 204 is able to execute the start restriction function by the above-described respective steps (particularly the determining step and the instructing step). As a result, it is possible to prevent the document of the user US2 from being erroneously read by an operation from the user US1. As described above, in the scan system 1000, even in the case where the general purpose scan software 202 does not support the start restriction function, it is possible to execute the start restriction function by the extension application 204.

It should be noted that in the first embodiment, a timing at which the extension application 204 inquires of the scan apparatus 102 about whether the remote scan is available (about whether the scan apparatus 102 is in the remote scan available state) has been set to a timing immediately before a scan instruction is issued, but is not limited to this timing immediately before a scan instruction is issued. For example, the timing of the inquiry may be a timing when the scan setting screen 300A shown in FIG. 3A is displayed, or the timing of the inquiry may be two timings: the timing immediately before a scan instruction is issued and the timing when the scan setting screen 300A is displayed.

In addition, the scan instruction in the step S613 is issued from the general purpose scan software 202 to the extension application 204, but the present disclosure is not limited to this. For example, the scan instruction may be issued from the scan application 201 to the extension application 204. In addition, a control for scan instruction may be arranged on the detailed setting screen 300C. In this case, a scan instruction is issued to the extension application 204 by the user operating the control for scan instruction. In addition, the image data may be transmitted from the scan apparatus 102 to the scan application 201 via the extension application 204 without going through the general purpose scan software 202. In addition, the image data may be transmitted directly from the scan apparatus 102 to the scan application 201. In addition, the scan system 1000 may be configured to be able to store (save) the scanned image data (the image data) in the external storage device 114 and transfer only information about a file path which is a storage destination. In addition, in the scan system 1000, in the case where there is a plurality of pieces of the scanned image data (the image data), all pieces of the scanned image data (the image data) may be transmitted en bloc, or the scanned image data (the image data) may be transmitted whenever it is obtained.

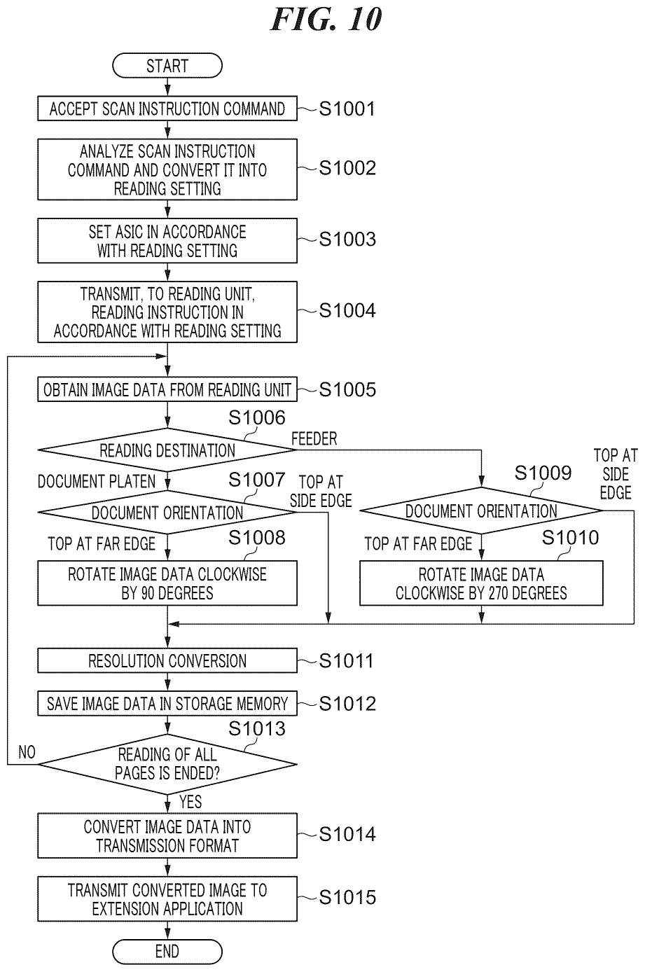

FIG. 10 is a flowchart that illustrates a processing executed by the scan apparatus. A program based on the flowchart illustrated in FIG. 10 is stored in the external storage device 199. The CPU 191 is able to execute the program by loading the program from the external storage device 199 into the RAM 193. As shown in FIG. 10, in a step S1001, the CPU 191 accepts the scan instruction command (see the step S617) from the extension application 204.

In a step S1002, the CPU 191 interprets the scan instruction command that has been accepted in the step S1001. Then, the CPU 191 converts the scan instruction command into a reading setting that allows the scan apparatus 102 to execute a scan processing, that is, a reading setting that allows to execute scanning under the setting condition on the detailed setting screen 300C.

In a step S1003, the CPU 191 decides an application specific integrated circuit (an ASIC) of the image processing unit 190 to be used for executing scanning in accordance with the setting (the reading setting) in the step S1002, and sets the ASIC.

In a step S1004, the CPU 191 transmits, to the reading unit 195, a reading instruction in accordance with the reading setting.

In a step S1005, the CPU 191 obtains the scanned image data (the image data) from the reading unit 195.

In a step S1006, the CPU 191 determines the reading destination. As a result of the determination in the step S1006, in the case of being determined that the reading destination is the document platen, the processing proceeds to a step S1007. On the other hand, as the result of the determination in the step S1006, in the case of being determined that the reading destination is the feeder, the processing proceeds to a step S1009.

In the step S1007, the CPU 191 determines the orientation of the document (a document orientation). As a result of the determination in the step S1007, in the case of being determined that the document orientation is “top at far edge”, that is, in the case where the control 309 has been selected, the processing proceeds to a step S1008. On the other hand, as the result of the determination in the step S1007, in the case of being determined that the document orientation is “top at side edge”, that is, in the case where the control 310 has been selected, the processing proceeds to a step S1011.

In the step S1008, the CPU 191 rotates the image data that has been obtained in the step S1005 by 90 degrees clockwise. After the step S1008 is executed, the processing proceeds to the step S1011.

In the step S1009, the CPU 191 determines the document orientation. As a result of the determination in the step S1009, in the case of being determined that the document orientation is “top at far edge”, the processing proceeds to a step S1010. On the other hand, as the result of the determination in the step S1009, in the case of being determined that the document orientation is “top at side edge”, the processing proceeds to the step S1011.

In the step S1010, the CPU 191 rotates the image data that has been obtained in the step S1005 by 270 degrees clockwise. After the step S1010 is executed, the processing proceeds to the step S1011.

In the step S1011, the CPU 191 controls the image processing unit 190 to perform a resolution conversion to 300×300 dpi with respect to the image data.

In a step S1012, the CPU 191 saves the image data, which has been subjected to the resolution conversion in the step S1011, in the external storage device 199 that is a storage memory.

In a step S1013, the CPU 191 determines whether or not the scan processing with respect to all pages of the document to be read has been ended. As a result of the determination in the step S1013, in the case of being determined that the scan processing with respect to all pages of the document to be read has been ended, the processing proceeds to a step S1014. On the other hand, as the result of the determination in the step S1013, in the case of being determined that the scan processing with respect to all pages of the document to be read has not been ended, the processing returns to the step S1005, and the subsequent steps are executed in sequence.

In the step S1014, the CPU 191 controls the image processing unit 190 to convert the image data that has been saved in the step S1012 into a transmission format. In the first embodiment, the transmission format is not included in the scan instruction command that has been accepted in the step S1001. Therefore, the scanned image data (the image data) is converted to, but not limited to, the default JPEG of the scan apparatus 102.

In a step S1015, the CPU 191 controls the input/output interface 198 to transmit, to the extension application 204, the image data that has been converted in the step S1014. After the step S1015 is executed, the processing ends.

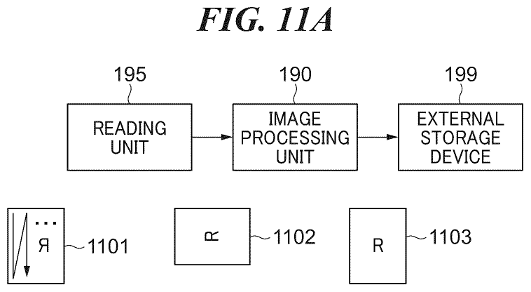

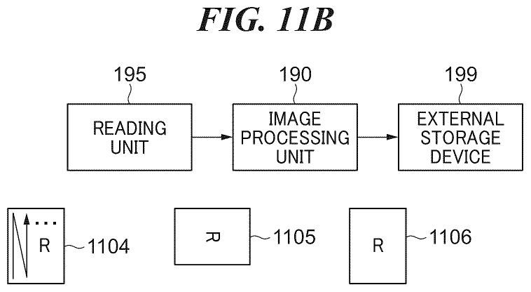

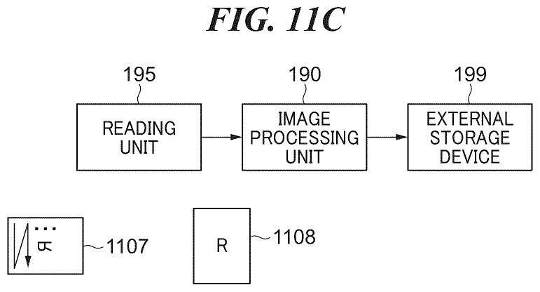

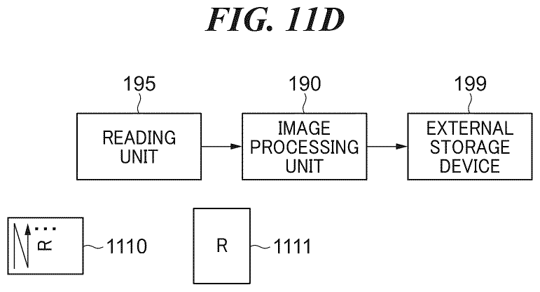

FIG. 11A, FIG. 11B, FIG. 11C, and FIG. 11D are diagrams for explaining an image processing according to the document orientation. As shown in FIG. 11A, a document 1101 is in a placed state where the top edge of the document 1101 is at the far edge and the printed side of the document 1101 faces downward. The document 1101 is read by the reading unit 195 in order from top to bottom in FIG. 11A as indicated by the direction of an arrow of FIG. 11A, and is recorded as image data 1102 in the RAM 193. The image data 1102 is data of an image facing left (facing the 9 o'clock position). Therefore, in order to orient this image toward the 0 o'clock position, it is necessary to rotate the image by 90 degrees clockwise by the image processing unit 190. By this rotation, the image data 1102 becomes image data 1103. The image data 1103 is data of an image in which the top edge of the document is facing up.

As shown in FIG. 11B, a document 1104 is in a placed state where the top edge of the document 1104 is at the far edge and the printed side of the document 1104 faces upward. The document 1104 is read by the reading unit 195 in order from bottom to top in FIG. 11B as indicated by the direction of an arrow of FIG. 11B, and is recorded as image data 1105 in the RAM 193. The image data 1105 is data of an image facing right (facing the 3 o'clock position). Therefore, in order to orient this image toward the 0 o'clock position, it is necessary to rotate the image by 270 degrees clockwise by the image processing unit 190. By this rotation, the image data 1105 becomes image data 1106. The image data 1106 is data of an image in which the top edge of the document is facing up.

As shown in FIG. 11C, a document 1107 is in a placed state where the top edge of the document 1107 is at the side edge and the printed side of the document 1107 faces downward. The document 1107 is read by the reading unit 195 in order from top to bottom in FIG. 11C as indicated by the direction of an arrow of FIG. 11C, and is recorded as image data 1108 in the RAM 193. The image data 1108 is data of an image in which the top edge of the document is facing up. Therefore, the rotation processing performed by the image processing unit 190 is omitted.

As shown in FIG. 11D, a document 1110 is in a placed state where the top edge of the document 1110 is at the side edge and the printed side of the document 1110 faces upward. The document 1110 is read by the reading unit 195 in order from bottom to top in FIG. 11D as indicated by the direction of an arrow of FIG. 11D, and is recorded as image data 1111 in the RAM 193. The image data 1111 is data of an image in which the top edge of the document is facing up. Therefore, the rotation processing performed by the image processing unit 190 is omitted.

### Second Embodiment

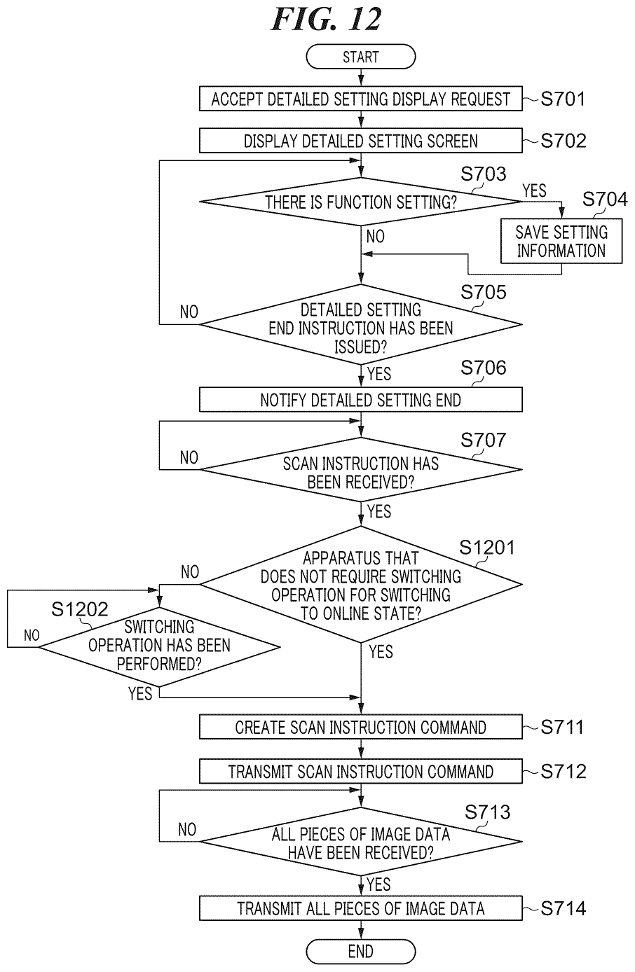

Hereinafter, a second embodiment of the present disclosure will be described with reference to FIG. 12. The differences from the embodiment described above will be mainly described, and descriptions of similar matters will be omitted. For example, in the case where the scan apparatus 102 is a small-sized apparatus that is capable of being installed on a desk, the host computer 101 may also be installed on the same desk as the scan apparatus 102. In such a usage environment, the user US1 tends to find the operation itself of switching to the online state to restrict use by the user US2 to be troublesome. Therefore, in the second embodiment, a configuration suitable for such a usage environment will be described.

FIG. 12 is a flowchart that illustrates a processing executed by an extension application according to the second embodiment. The flowchart shown in FIG. 12 differs from the flowchart shown in FIG. 7 in that a step S1201 is executed instead of the step S708 and the step S709, and a step S1202 is executed instead of the step S710. As shown in FIG. 12, as a result of the determination in the step S707, in the case of being determined that the scan instruction has been received from the general purpose scan software 202, the processing proceeds to the step S1201. In the step S1201, the extension application 204 (the extension application according to the second embodiment) determines whether or not the scan apparatus 102 is an apparatus that does not require a switching operation for switching to the online state. This determination is made based on, for example, a name of the scan apparatus 102 and a table describing products that need to be switched to the online state and products that do not need to be switched to the online state. It should be noted that the name of is included in the capability information. In addition, the table is stored in advance in the external storage device 114. The name of the scan apparatus 102 and the table are used as apparatus information regarding whether the scan apparatus 102 is an apparatus that needs to be switched to the online state or not. As a result of the determination in the step S1201, in the case of being determined that the scan apparatus 102 is an apparatus that does not require a switching operation for switching to the online state, the processing proceeds to the step S711, and the subsequent steps are executed in sequence. On the other hand, as the result of the determination in the step S1201, in the case of being determined that the scan apparatus 102 is not an apparatus that does not require a switching operation for switching to the online state, the processing proceeds to the step S1202.

In the step S1202, the extension application 204 (the extension application according to the second embodiment) determines whether or not a switching operation has been performed. As a result of the determination in the step S1202, in the case of being determined that a switching operation has been performed, the processing proceeds to the step S711, and the subsequent steps are executed in sequence. On the other hand, as the result of the determination in the step S1202, in the case of being determined that a switching operation has not been performed, the processing remains in the step S1202 and waits.

In this way, in the second embodiment, depending on the type of the scan apparatus 102, it is possible to omit the operation of switching to the online state to restrict use by the user US2 who is another user (another person) to the user US1.

### Third Embodiment

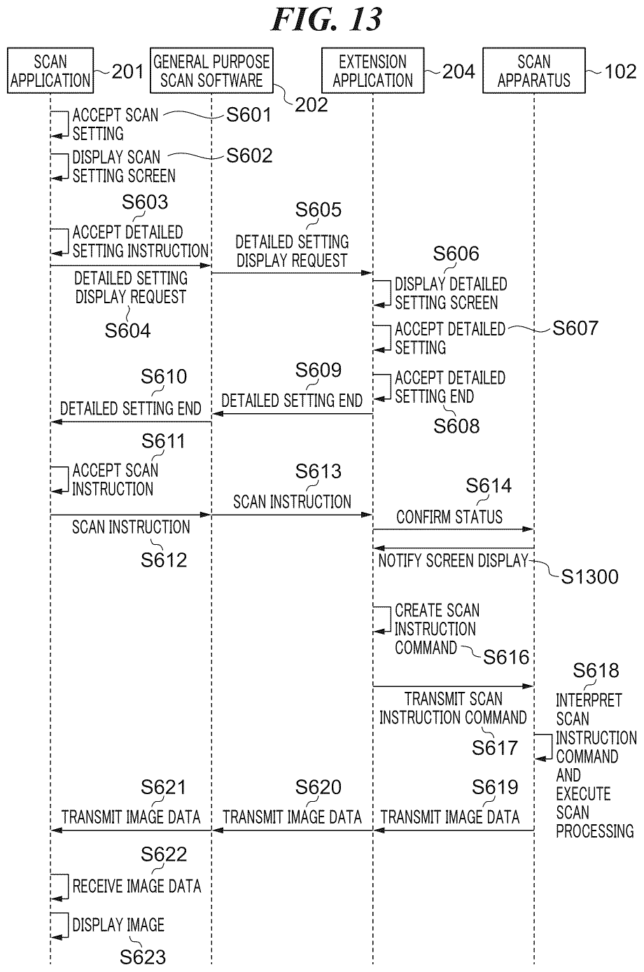

Hereinafter, a third embodiment of the present disclosure will be described with reference to FIG. 13. The differences from the embodiments described above will be mainly described, and descriptions of similar matters will be omitted. FIG. 13 is a sequence diagram that illustrates processes executed between a scan application according to the third embodiment, the general purpose scan software, the extension application, and the scan apparatus after the scan application according to the third embodiment accepts a scan setting. The sequence diagram shown in FIG. 13 differs from the sequence diagram shown in FIG. 6 in that a step S1300 is executed instead of the step S615. As shown in FIG. 13, in the step S1300, the scan apparatus 102 displays the home screen 901 (see FIG. 9A). As a result, it is estimated that the scan apparatus 102 at a time point when the home screen 901 is displayed is not being operated by any user, including the user US1 and the user US2. It should be noted that in the third embodiment, the home screen 901 is obtained by the extension application 204 as information on whether or not the setting screen 906B will be displayed after the home screen 901 is displayed, that is, information on whether or not to display the setting screen 906B. Furthermore, in the case where the home screen 901 is displayed, that is, in the case where the setting screen 906B is capable of being displayed, it is determined that a remote scan instruction is allowed with respect to the scan apparatus 102.

According to the present disclosure, when causing the image processing apparatus including the reading function for reading a document to execute the reading function, it is possible to cause to execute the start restriction function without using the scan driver.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023544, filed Feb. 17, 2025, which is hereby incorporated by reference herein in its entirety.

What is claimed is:

1. A non-transitory computer-readable storage medium storing an application program, which supports a standard driver provided by a provider of an operating system, for causing a computer to execute
an obtaining step of obtaining, from an image processing apparatus including a reading function for reading a document, state information relating to a state of the image processing apparatus;
a determining step of determining whether or not the image processing apparatus is capable of executing the reading function based on the state information that has been obtained in the obtaining step; and
an instructing step of, as a result of the determination in the determining step, in a case of being determined that an instruction to execute the reading function is allowed, issuing the instruction to execute the reading function.

2. The non-transitory computer-readable storage medium according to claim 1, wherein
the image processing apparatus is capable of being set to an acceptance state that accepts an instruction to execute the reading function from the computer, and
in the obtaining step, in a case where the image processing apparatus has been set to the acceptance state, setting information indicating that the image processing apparatus has been set to the acceptance state is obtained as the state information.

3. The non-transitory computer-readable storage medium according to claim 2, wherein
the image processing apparatus displays a setting screen that allows the acceptance state to be set, and
in the obtaining step, information displayed on the setting screen is obtained as the state information.

4. The non-transitory computer-readable storage medium according to claim 1, wherein
in the obtaining step, apparatus information regarding whether the image processing apparatus is an apparatus that needs to be switched to an online state or not is capable of being obtained.

5. The non-transitory computer-readable storage medium according to claim 1, wherein
the image processing apparatus displays a setting screen that allows an acceptance state, which accepts an instruction to execute the reading function from the computer, to be set, and
in the obtaining step, information regarding whether or not the setting screen is to be displayed on the image processing apparatus is obtained as the state information.

6. The non-transitory computer-readable storage medium according to claim 5, wherein
in the determining step, in a case where the setting screen is displayed on the image processing apparatus, it is determined that the instruction to execute the reading function from the computer is allowed.

7. The non-transitory computer-readable storage medium according to claim 1, wherein
the application program further causes the computer to execute an informing step of, as the result of the determination in the determining step, in a case of being determined that an instruction to execute the reading function is not allowed, informing that an instruction to execute the reading function is not allowed.

8. The non-transitory computer-readable storage medium according to claim 1, wherein
the application program further causes the computer to execute a display control step of, prior to the determining step, causing to display an acceptance screen for accepting information required for causing the image processing apparatus to execute the reading function.

9. The non-transitory computer-readable storage medium according to claim 1, wherein
the image processing apparatus is capable of being in an overlapping state, in which a plurality of instructions to execute the reading function with respect to the image processing apparatus overlap,
the standard driver does not include a restriction function that allows one instruction to execute the reading function among from the plurality of instructions to execute the reading function that are in the overlapping state, while restricting the remaining instructions to execute the reading function, and
the application program is capable of executing the restriction function through the determining step and the instructing step.

10. The non-transitory computer-readable storage medium according to claim 1, wherein
the standard driver is a program that operates based on the Internet Printing Protocol.

11. A control method for performing control that supports a standard driver provided by a provider of an operating system, the control method comprising:
an obtaining step of obtaining, from an image processing apparatus including a reading function for reading a document, state information relating to a state of the image processing apparatus;
a determining step of determining whether or not the image processing apparatus is capable of executing the reading function based on the state information that has been obtained in the obtaining step; and
an instructing step of, as a result of the determination in the determining step, in a case of being determined that an instruction to execute the reading function is allowed, issuing the instruction to execute the reading function.

12. An information processing apparatus comprising a standard driver provided by a provider of an operating system and an application program that supports the standard driver, wherein
the application program causes a computer of the information processing apparatus to execute
an obtaining step of obtaining, from an image processing apparatus including a reading function for reading a document, state information relating to a state of the image processing apparatus;
a determining step of determining whether or not the image processing apparatus is capable of executing the reading function based on the state information that has been obtained in the obtaining step; and
an instructing step of, as a result of the determination in the determining step, in a case of being determined that an instruction to execute the reading function is allowed, issuing the instruction to execute the reading function.
